(19) United States
(12) Patent Application Publication
(10) Pub. No.: US 2010/0302355 A1
(43) Pub. Date: Dec. 2, 2010

(54) STEREOSCOPIC IMAGE DISPLAY APPARATUS AND CHANGEOVER METHOD

(76) Inventor: Masaya TAMARU, Miyagi (JP)

Correspondence Address: BIRCH STEWART KOLASCH & BIRCH, PO BOX 747, FALLS CHURCH, VA, 22040-0747, US

(21) Appl. No.: 12/789,719

(22) Filed: May 28, 2010

(30) Foreign Application Priority Data
May 29, 2009 (JP) 2009-130712

(51) Int. Cl. H04N 13/04

(52) U.S. Cl. 348/59; 348/E13.075

(57) ABSTRACT

A stereoscopic image display apparatus includes an image receiving device for retrieving right and left eye images of plural stereo pairs obtained stereoscopically from a storage medium by one pair. A parallax checking device determines parallax information of parallax of a common principal object present in each of the right and left eye images being retrieved. A stereo matching unit corrects a right eye image in projective transformation to minimize the parallax information being determined. A display panel displays a three dimensional image according to the right and left eye images after correcting the right eye image. A controller, while the display panel displays the three dimensional image, causes retrieval of the right and left eye images and determination of the parallax information thereof with the image receiving device and the parallax checking device with respect to a succeeding stereo pair among the plural stereo pairs.

### BACKGROUND OF THE INVENTION

1. Field of the Invention

The present invention relates to a stereoscopic image display apparatus and changeover method. More particularly, the present invention relates to a stereoscopic image display apparatus in which a three dimensional image is displayed according to right and left eye images, and changeover of the in three dimensional image can be quickly carried out, and changeover method of changing over the three dimensional image.

2. Description Related to the Prior Art

JP-A 11-252585 and JP-A 10-040420 disclose an autostereoscopic display apparatus as a stereoscopic image display apparatus. A camera photographs component images or right and left eye images. The right and left eye images are displayed in a separate manner for eyes of a viewer. Thus, a three dimensional image is displayed in combination of the right and left eye images with a parallax or disparity. There are various definitions of the parallax as a parameter for stereoscopic appearance. An example of the parallax is a difference value between pixels of common points between the right and left eye images. See FIG. 4 for feature points and relevant points as common points.

In the autostereoscopic display apparatus, the parallax or disparity occurs between small objects such as background object other than a principal object between the right and left eye images. Stereo matching is made with zero parallax of the principal object in the right and left eye images such as a person. Then the three dimensional image appears in such a manner the objects are visible nearer or farther to the viewer's eyes than the principal object. See the lower section of FIG. 9.

To display the three dimensional image, it is known to reduce the parallax of the principal object between the right and left eye images to zero for the purpose of decreasing physical fatigue of eyes of the viewer. This is because of accommodation-convergence mismatch described in JP-A 2006-262191, in which the parallax of the principal object gazed by the viewer with highest attention might cause a serious problem.

To reduce physical fatigue of eyes due to the accommodation-convergence mismatch, parallax information or disparity information as an amount of the parallax of the principal object between the right and left eye images is determined in the autostereoscopic display apparatus. The right and left eye images are corrected to set the parallax information to zero before the three dimensional image is displayed.

It is possible easily to obtain the parallax information or disparity information of the principal object between the right and left eye images as two dimensional vector (difference in the position in the X and Y directions) if a first one of the principal object only translates relative to a second one of the principal object. However, the parallax information cannot be determined as a two dimensional vector should there be a rotation, scaling or distortion between the first and second of the principal object in addition to the translation. For such a situation, projective transformation parameters must be determined to reduce the parallax information of the principal object to zero, because one of the right and left eye images must be transformed in the projective transformation. This requires extremely long process time to obtain the parallax information due to complicated arithmetic operation. Delay is likely to occur as considerable time lag to display a second one of the three dimensional image upon changeover of a first one the three dimensional image.

### SUMMARY OF THE INVENTION

In view of the foregoing problems, an object of the present invention is to provide a stereoscopic image display apparatus in which a three dimensional image is displayed according to right and left eye images, and changeover of the in three dimensional image can be quickly carried out, and changeover method of changing over the three dimensional image.

In order to achieve the above and other objects and advantages of this invention, a stereoscopic image display apparatus includes an image receiving device for retrieving right and left eye images of plural stereo pairs from a storage medium by one pair. A parallax checking device determines parallax information of parallax of a common principal object present in each of the right and left eye images of an Nth stereo pair, where N is an integer. A stereo matching unit corrects at least one particular image of the right and left eye images of the Nth stereo pair to minimize the parallax information being determined. A display panel displays an Nth three dimensional image according to the right and left eye images of the Nth stereo pair after correction. A controller, while the display panel displays the Nth three dimensional image, causes retrieval of the right and left eye images of an (N+1)th stereo pair and determination of the parallax information thereof with the image receiving device and the parallax checking device with respect to the (N+1)th stereo pair.

The parallax checking device includes an image analysis unit for image analysis of the right and left eye images. A parameter determiner determines a geometric transformation parameter to represent the parallax information of the object between the right and left eye images according to a result of the image analysis. The stereo matching unit corrects the particular image according to geometric transformation by use of the geometric transformation parameter.

The geometric transformation is projective transformation or affine transformation.

The image analysis unit includes an object detector for detecting the object from the right and left eye images. A feature point detector detects a feature point associated with the object within the particular image. A relevant point detector detects a relevant point corresponding to the feature point from the object within a remaining image of the right and left eye images.

The parameter determiner obtains the geometric transformation parameter by a method of least squares according to the feature point and the relevant point.

Furthermore, a changeover device changes over the three dimensional image on the display panel. The stereo matching unit carries out the correction of at least one of the right and left eye images of the (N+1)th stereo pair according to the parallax information upon changeover of the changeover device from the Nth three dimensional image to an (N+1)th three dimensional image.

The stereo matching unit carries out correction gradually to decrease the parallax information. The display panel updates display of the three dimensional image at each time of correction of the parallax information with the stereo matching unit.

The stereo matching unit carries out initial correction to minimize second parallax information of an area of the object within the right and left eye images of the Nth stereo pair equal to an area of presence of a common principal object in right and left eye images of an (N−1)th stereo pair, according to parallax information determined earlier by the parallax checking device for the (N−1)th stereo pair. Then the stereo matching unit carries out correction gradually to decrease the parallax information of the right and left eye images after the initial correction.

The right and left eye images are photographed by a stereoscopic imaging apparatus including first and second imaging assemblies, disposed beside one another, for creating the right and left eye images by photographing the object. A parallax detection device detects parallax information of the object present in the right and left eye images from the first and second imaging assemblies. A recording control unit writes data of the right and left eye images and the parallax information of the object associated with the right and left eye images to a storage medium. The parallax checking device reads the parallax information from the storage medium for determination thereof.

The display panel splits the particular image being corrected into stripe regions of a first group extending in a predetermined direction, splits a remaining image of the right and left eye images into stripe regions of a second group extending in the predetermined direction, and creates the three dimensional image according to a lenticular method by alternately combining the stripe regions of the first and second groups.

Also, a changeover method of changing over display of a three dimensional image is provided, and includes a step of retrieving right and left eye images of plural stereo pairs from a storage medium by one pair. Parallax information of parallax of a common principal object present in each of the right and left eye images of an Nth stereo pair is determined, where N is an integer. At least one particular image of the right and left eye images of the Nth stereo pair is corrected to minimize the parallax information being determined. An Nth three dimensional image is displayed on a display panel according to the right and left eye images of the Nth stereo pair. While the display panel displays the Nth three dimensional image, carrying out the retrieving step and the determining step with respect to an (N+1)th stereo pair.

The correcting step and the display step are carried out for the (N+1)th stereo pair when the display panel is changed over from the Nth three dimensional image to an (N+1)th three dimensional image.

Also, a computer executable program for stereoscopic image display includes a retrieving program code for retrieving right and left eye images of plural stereo pairs obtained stereoscopically from a storage medium by one pair. A determining program code is for determining first parallax information of parallax of a common principal object present in each of the right and left eye images being retrieved. A correcting program code is for correcting at least a first image of the right and left eye images to minimize the first parallax information being determined. A display program code is for displaying a three dimensional image on a display panel according to the right and left eye images after correcting at least the first image. A control program code is for, while the display panel displays the three dimensional image, causing retrieval of the right and left eye images and determination of the first parallax information thereof with the retrieving program code and the determining program code with respect to a succeeding stereo pair among the plural stereo pairs.

Consequently, changeover of the three dimensional image can be quickly carried out because data for the succeeding stereo pair of right and left eye images are processed in an early manner during display of the three dimensional image of the present stereo pair.

### BRIEF DESCRIPTION OF THE DRAWINGS

The above objects and advantages of the present invention will become more apparent from the following detailed description when read in connection with the accompanying drawings, in which:

FIG. 1 is a block diagram illustrating an autostereoscopic display apparatus;

FIG. 2 is a block diagram illustrating an image processor;

FIG. 3 is a block diagram illustrating a parallax checking device;

FIG. 4A is a plan illustrating extraction of feature points from a principal object of a left eye image;

FIG. 4B is a plan illustrating detection of relevant points from the principal object of a right eye image;

FIG. 5 is a table illustrating information in a relevant coordinate table;

FIGS. 6A and 6B are explanatory views in plans illustrating one stereo pair of right and left eye images between which a principal object is photographed differently;

FIG. 7A is a graph illustrating determination of a correction value with a condition generator of FIG. 2;

FIG. 7B is a graph illustrating another setting of a correction value;

FIG. 8 is a flow chart illustrating a sequence of display of the autostereoscopic display apparatus;

FIG. 9 is an explanatory view in a plan illustrating correction of an initial stereo pair of right and left eye images;

FIG. 10 is an explanatory view in a plan illustrating correction of a succeeding stereo pair before changeover of a three dimensional image;

FIGS. 11A and 11B are plans illustrating correction according to projective transformation;

FIG. 12 is a block diagram illustrating a three dimensional camera of another preferred embodiment;

FIG. 13 is a flow chart illustrating a sequence of display of an autostereoscopic display apparatus of the embodiment.

### DETAILED DESCRIPTION OF THE PREFERRED EMBODIMENT(S) OF THE PRESENT INVENTION

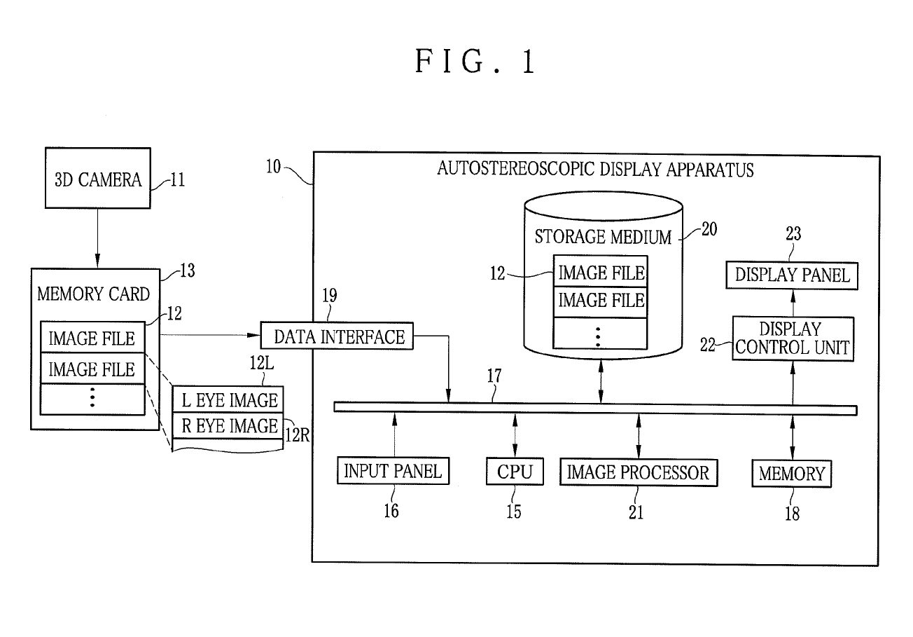

In FIG. 1, an autostereoscopic display apparatus 10 or stereoscopic image display apparatus is illustrated. A left eye image 12L and a right eye image 12R or component images are formed previously by imaging in a three dimensional camera 11 or stereo camera or stereoscopic imaging apparatus. The three dimensional camera 11 creates the right and left eye images 12L and 12R by photographing an object with two light paths. An image file 12 is produced by combining the right and left eye images 12L and 12R. A memory card 13 is accessed by the three dimensional camera 11 to store the image file 12.

A CPU 15 is incorporated in the autostereoscopic display apparatus 10. An input panel 16 as changeover device generates a control signal which is input to the CPU 15. A memory 18 is accessed by the CPU 15, which reads various programs and data, performs tasks by running the programs, and controls the entirety of elements in the autostereoscopic display apparatus 10. The various elements are connected to the CPU 15 by a data bus 17, including a data interface 19, a storage medium 20, an image processor 21, a display control unit 22 and a monitor display panel 23 as well as the input panel 16 and the memory 18.

The input panel 16 includes a power switch, start switch, changeover switch and the like. The start switch is operable for starting displaying a three dimensional image. The changeover switch is operable for changing over the three dimensional image on the monitor display panel 23. The memory 18 stores the above-described programs and data, and is a working memory with which the CPU 15 performs tasks. Also, the memory 18 operates as a VRAM.

The data interface 19 retrieves the image file 12 originally recorded by the three dimensional camera 11 from the memory card 13. The image file 12 is sent from the data interface 19 through the data bus 17 successively to the storage medium 20.

The storage medium 20 stores a plurality of the image files 12 from the data interface 19. The image processor 21 performs tasks of reading, detecting parallax information or disparity information, and stereo matching. In the reading, the image processor 21 reads the image files 12 from the storage medium 20 in a predetermined sequence. In the parallax detection, the image processor 21 detects first parallax information of parallax of a principal object within each of the right and left eye images 12L and 12R in the image files 12. In the stereo matching, the right eye image 12R is corrected according to the parallax information.

The display control unit 22 creates a stripe pattern image by alternately arranging stripe regions of the right and left eye images 12L and 12R corrected by the image processor 21 in stripe shapes, and outputs the stripe pattern image to the monitor display panel 23. A lenticular lens is disposed in front of the monitor display panel 23, and passes image light of numerous stripe regions of the left eye image 12L toward a left eye of a viewer, and passes image light of numerous stripe regions of the right eye image 12R toward his or her right eye. The viewer can see a three dimensional image by looking at the left eye image 12L with the left eye and the right eye image 12R with the right eye.

Let a “three dimensional image” be the stripe pattern image in the description. Let display of the three dimensional image be display of the stripe pattern image on the monitor display panel 23. Let a “present stereo pair” be a set of the right and left eye images 12L and 12R on the monitor display panel 23 by way of the three dimensional image. Let a “succeeding stereo pair” be a set of the right and left eye images 12L and 12R displayed immediately after the present stereo pair.

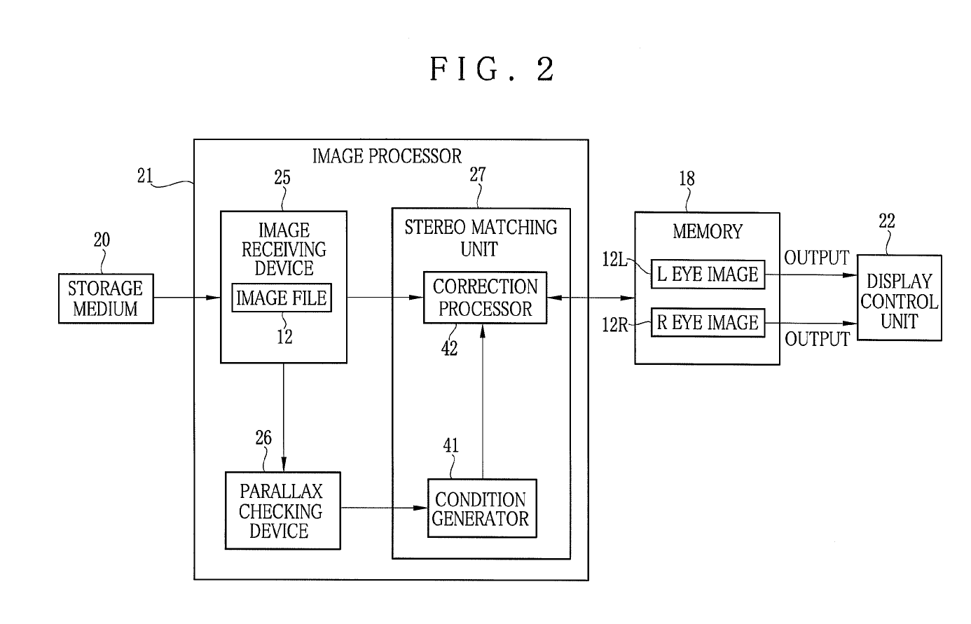

In FIG. 2, the image processor 21 includes an image receiving device 25, a parallax checking device 26 and a stereo matching unit 27 or parallax correction device.

The image receiving device 25 reads the image files 12 from the storage medium 20 sequentially. Examples of sequences of reading are a sequence of file names (PIC1, PIC2, PIC3 and the like), a sequence of dates of image pickup, a retrograde sequence of the dates of image pickup, and the like. When a signal of starting the display is input by the input panel 16, a first one of the image files 12 is read by the image receiving device 25 from the storage medium 20, and stored temporarily. While the monitor display panel 23 displays a three dimensional image, the image receiving device 25 reads a second one of the image files 12 from the storage medium 20, and writes the same by overwriting at the first image file.

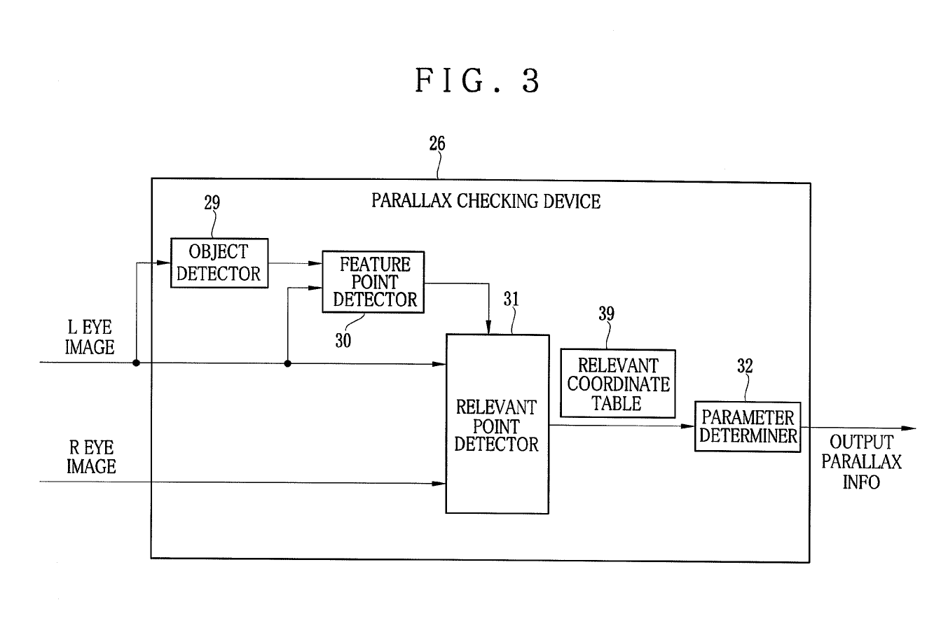

In FIG. 3, the parallax checking device 26 analyzes the right and left eye images 12L and 12R included in the image files 12 from the image receiving device 25, and carries out the parallax detection. The parallax checking device 26 includes an object detector 29 for a principal object, a feature point detector 30 or feature point extractor, a relevant point detector 31, and a parallax detector or geometric transformation parameter determiner 32.

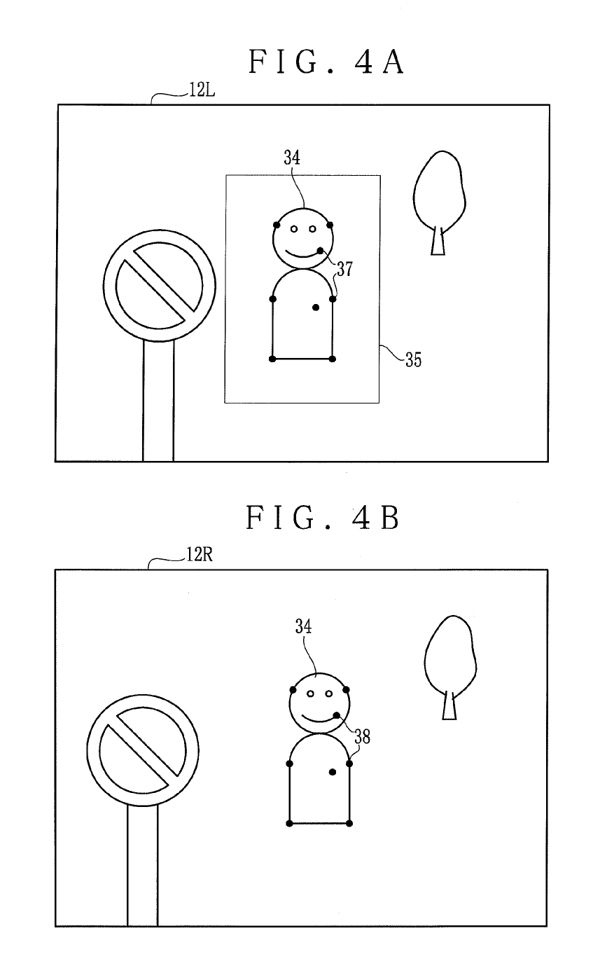

In FIG. 4A, the object detector 29 or image analysis unit analyzes the left eye image 12L. A principal object area 35 in presence of a principal object 34 is detected from the left eye image 12L by the object detector 29. The principal object 34 is a single person in each of the right and left eye images 12L and 12R. The object detector 29 detects a position of the person's face, and determines the principal object area 35 by designating a local area containing the face around the face position. If no person is present in the left eye image 12L, the object detector 29 designates a center area of the image as the principal object area 35. Various known methods other than this method may be used for detecting the principal object area 35 or a person. If plural persons are present in the left eye image 12L, a particular one of those is designated, for example, the person of the nearest distance, the person at the center, or the like.

The feature point detector 30 extracts a plurality of feature points 37 from the principal object area 35 in the left eye image 12L by image analysis according to the output from the object detector 29. The feature points 37 are pixels where a pixel value changes characteristically within the principal object area 35. Preferable examples of the feature points 37 are pixels at corners, end points or the like where the pixel value changes horizontally and vertically. Examples of methods of extracting feature points are Harris algorithm, Moravec method, Shi-Tomasi's method and the like.

In FIG. 4B, the relevant point detector 31 analyzes the right and left eye images 12L and 12R according to information from the feature point detector 30, and detects position information of relevant points 38 within the right eye image 12R corresponding to respectively the feature points 37. Examples of methods of the point detection are block matching method, KLT (Kanade Lucas Tomasi) tracker method and the like. A relevant coordinate table 39 is created by the relevant point detector 31 according to the information of the relevant points and the feature points. The relevant coordinate table 39 is a table of relationships between the feature points 37 and the relevant points 38.

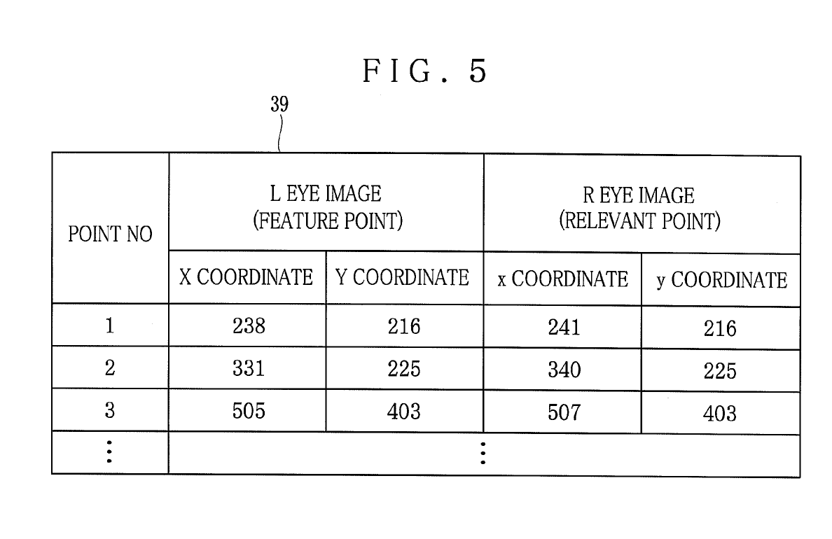

In FIG. 5, the relevant coordinate table 39 is a table in which a location of the feature points 37 in the left eye image 12L or X and Y-coordinates correspond to a location in the right eye image 12R or x and y-coordinates of the relevant points 38. Note that an origin of the coordinate system is defined at a pixel at a lower left corner of the right and left eye images 12L and 12R to indicate the X and Y-coordinates and x and y-coordinates. If (X, Y)=(238, 216), then the feature point 37 is a 239th pixel in the X direction from the origin, and also a 217th pixel in the Y direction.

In FIG. 3, the parameter determiner 32 refers to the relevant coordinate table 39 and obtains eight projective transformation parameters a, b, c, d, s, t, p and q for use in the projective transformation by way of parallax information or disparity information of the principal object 34 between the right and left eye images 12L and 12R. The projective transformation is a geometric transformation in which an image photographed from a certain point of view is transformed into an image which would be photographed from a different point geometrically according to the projective transformation parameters in such functions as translation, rotation, scaling and trapezoidal distortion. The projective transformation parameters a, b, c, d, s, t, p and q are so determined as to eliminate parallax or disparity of the principal object 34 between the right and left eye images 12L and 12R by projective transformation of the right eye image 12R.

A method of obtaining projective transformation parameters a, b, c, d, s, t, p and q according to the relevant coordinate table 39 is described now. The projective transformation is carried out according to Equations 1 and 2 below. Let (X, Y) be coordinates of each one of the feature points 37. Let (x, y) be coordinates of each one of the relevant points 38.

X=(ax+by+s)/(px+qy+1) [Equation 1]

Y=(cx+dy+t)/(px+qy+1) [Equation 2]

To determine the projective transformation parameters a, b, c, d, s, t, p and q from the relevant coordinate table 39, the method of least squares is used. Specifically, the projective transformation parameters a, b, c, d, s, t, p and q to minimize values of evaluation functions Jₓ and J_{y} of Equations 3 and 4 are obtained. Note that (Xᵢ, Yᵢ) and (xᵢ, yᵢ) are coordinates of the feature point 37 and the relevant point 38 of an ith combination in the relevant coordinate table 39. N is the number of feature points and the number of relevant points.

$$\begin{matrix}{J}_{x} = {\sum }_{i = 1}^{N} {[ ( {px}_{i} + {qy}_{i} + 1 ) {X}_{i} - ( {ax}_{i} + {by}_{i} + s ) ]}^{2} & [ Equation 3 ] \\ {J}_{y} = {\sum }_{i = 1}^{N} {[ ( {px}_{i} + {qy}_{i} + 1 ) {Y}_{i} - ( {cx}_{i} + {dy}_{i} + t ) ]}^{2} & [ Equation 4 ]\end{matrix}$$

Values of the projective transformation parameters to minimize the evaluation functions Jₓ and J_{y}, are obtained by solving the eight simultaneous equations, which are obtained by partially differentiating the evaluation functions Jₓ and J_{y} with respect to respectively the parameters and of which the values are set equal to zero (0).

$$\begin{matrix}\frac{\partial {J}_{x}}{\partial a} = - 2 {\sum }_{i = 1}^{N} ( \begin{matrix}{px}_{i}^{2} {X}_{i} + {qx}_{i} {y}_{i} {X}_{i} + \\ {x}_{i} {X}_{i} - {ax}_{i}^{2} - {bx}_{i} {y}_{i} - {sx}_{i}\end{matrix} ) = 0 & [ Equation 5 ] \\ \frac{\partial {J}_{x}}{\partial b} = - 2 {\sum }_{i = 1}^{N} ( \begin{matrix}{px}_{i} {y}_{i} {X}_{i} + {qy}_{i}^{2} {X}_{i} + \\ {y}_{i} {X}_{i} - {ax}_{i} {y}_{i} - {by}_{i}^{2} - {sy}_{i}\end{matrix} ) = 0 & [ Equation 6 ] \\ \frac{\partial {J}_{x}}{\partial s} = - 2 {\sum }_{i = 1}^{N} ( \begin{matrix}{px}_{i} {X}_{i} + {qy}_{i} {X}_{i} + \\ {X}_{i} - {ax}_{i} - {by}_{i} - s\end{matrix} ) = 0 & [ Equation 7 ] \\ \frac{\partial {J}_{y}}{\partial c} = - 2 {\sum }_{i = 1}^{N} ( \begin{matrix}{px}_{i}^{2} {Y}_{i} + {qx}_{i} {y}_{i} {Y}_{i} + \\ {x}_{i} {Y}_{i} - {cx}_{i}^{2} - {dx}_{i} {y}_{i} - {tx}_{i}\end{matrix} ) = 0 & [ Equation 8 ] \\ \frac{\partial {J}_{y}}{\partial d} = - 2 {\sum }_{i = 1}^{N} ( \begin{matrix}{px}_{i} {y}_{i} {Y}_{i} + {qy}_{i}^{2} {Y}_{i} + \\ {y}_{i} {Y}_{i} - {cx}_{i} {y}_{i} - {dy}_{i}^{2} - {ty}_{i}\end{matrix} ) = 0 & [ Equation 9 ] \\ \frac{\partial {J}_{y}}{\partial t} = - 2 {\sum }_{i = 1}^{N} ( \begin{matrix}{px}_{i} {Y}_{i} + {qy}_{i} {Y}_{i} + \\ {Y}_{i} - {cx}_{i} - {dy}_{i} - t\end{matrix} ) = 0 & [ Equation 10 ] \\ \frac{\partial {J}_{x}}{\partial p} = 2 {\sum }_{i = 1}^{N} ( \begin{matrix}{px}_{i}^{2} {X}_{i}^{2} + {qx}_{i} {y}_{i} {X}_{i}^{2} + {x}_{i} {X}_{i}^{2} - \\ {ax}_{i}^{2} {X}_{i} - {bx}_{i} {y}_{i} {X}_{i} - {sx}_{i} {X}_{i}\end{matrix} ) = 0 & [ Equation 11 ] \\ \frac{\partial {J}_{x}}{\partial q} = 2 {\sum }_{i = 1}^{N} ( \begin{matrix}{px}_{i} {y}_{i} {X}_{i}^{2} + {qy}_{i}^{2} {X}_{i}^{2} + {y}_{i} {X}_{i}^{2} - \\ {ax}_{i} {y}_{i} {X}_{i} - {by}_{i}^{2} {X}_{i} - {sy}_{i} {X}_{i}\end{matrix} ) = 0 & [ Equation 12 ]\end{matrix}$$

The above-described projective transformation parameters a, b, c, d, s, t, p and q are values corresponding to parallax information or disparity information of the principal object 34 between the right and left eye images 12L and 12R. If the parallax information of the principal object 34 between the right and left eye images 12L and 12R is zero (0) in stereo matching, the projective transformation parameters (a,b,c,d,s,t,p,q) are (1,0,0,1,0,0,0,0). Values of the eight symbols are hereinafter referred to simply as projective transformation parameters.

In FIG. 2, the stereo matching unit 27 corrects the right eye image 12R of the image file 12 read from the image receiving device 25 by the projective transformation according to the projective transformation parameters obtained by the parameter determiner 32. The stereo matching unit 27 writes the right eye image 12R after the correction to the memory 18, to which the left eye image 12L of an original form is written.

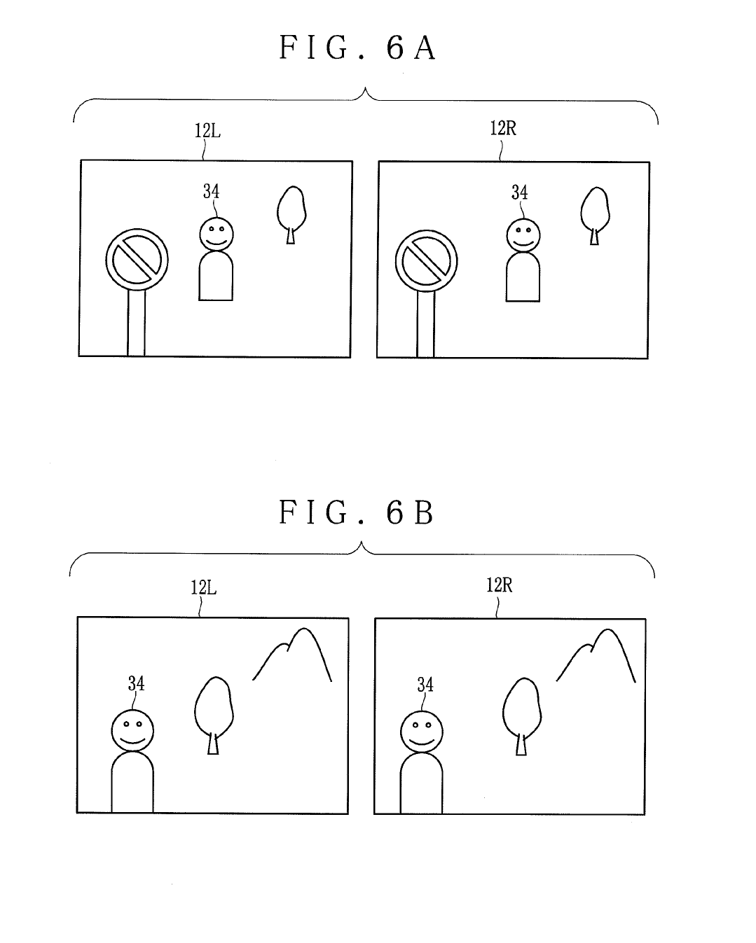

In FIG. 6A, if the principal object 34 is located at each center of the right and left eye images 12L and 12R, the right eye image 12R is corrected by the stereo matching unit 27 to reduce the parallax information of the principal object 34 to zero (0). Also, the stereo matching unit 27 corrects the right eye image 12R for stereo matching of the principal object 34 if the principal object 34 is photographed in FIG. 6B at a nearer distance than that in FIG. 6A and at a point different from that in FIG. 6A. Should the monitor display panel 23 be changed over from the three dimensional image with zero parallax of the principal object 34 in FIG. 6A to that with zero parallax of the principal object 34 in FIG. 6B, then a stereo angle of a viewer, namely angle defined between the two eyes with respect to the object, is changed abruptly to cause physical fatigue in the sight.

Thus, the stereo matching unit 27 carries out an initial correction of the right eye image 12R of a succeeding stereo pair according to the projective transformation parameters obtained for the present stereo pair. Let the present stereo pair have the form in FIG. 6A. Let the succeeding stereo pair have the form in FIG. 6B. The initial correction sets second parallax information at zero (0) at first, the second parallax information being a value of a tree located at the center of the succeeding stereo pair of the right and left eye images. Then the stereo matching unit 27 corrects the right eye image 12R stepwise in plural steps gradually to decrease the parallax information of the principal object 34 in the succeeding stereo pair after the initial correction. Note that K steps of the correction include the step of the initial correction, where K is a natural number.

In FIG. 2, the stereo matching unit 27 includes a condition generator 41 for a correction value and a correction processor 42. The condition generator 41 determines a correction value Xm for correcting the right eye image 12R in each of first to Kth steps according to the projective transformation parameters obtained by the parameter determiner 32, where m is from 1 to K. The correction value Xm is expressed by the projective transformation parameters.

For example, only translation is carried out in the correction or projective transformation. A correction value Xm is obtained by Equation 13 indicated below. For the purpose of clarity, description of determination of the correction value Xm is omitted in relation to such examples of geometric transformation as rotation, scaling for a larger or smaller size, trapezoidal distortion, and the like.

Xm=(A−A0)/K [Equation 13]

In Equation 13, A0 is an initial correction value expressed with the projective transformation parameters obtained for the present stereo pair. A is parallax information of the succeeding stereo pair expressed with the projective transformation parameters. After the power source is turned on, the initial correction value A0 is (a,b,c,d,s,t,p,q)=(1,0,0,1,0,0,0,0) for correction of an initial pair of the right and left eye images 12L and 12R. Upon changeover of a three dimensional image, the parallax information A before the changeover is used as the initial correction value A0.

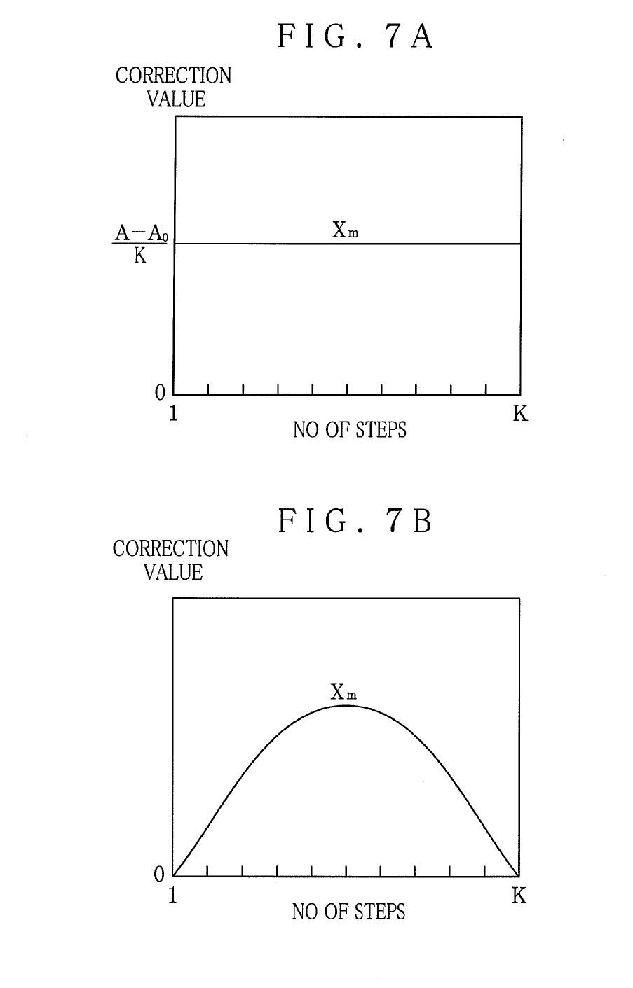

In FIG. 7A, correction values X1-XK obtained from Equation 13 are equal to one another. A change amount or translation amount of the principal object 34 of the right eye image 12R at the first to Kth steps is equal. Note that it is possible in FIG. 7B to change Equation 13 to cause the change amount of the principal object 34 of the right eye image 12R in the first to Kth steps to change parabolically according to the increase in the number of the steps.

In FIG. 2, the correction processor 42 corrects the right eye image 12R in stepwise correction of the first to Kth steps according to the correction value Xm determined by the condition generator 41. In the first step, the correction processor 42 corrects the right eye image 12R according to the correction value X1 and writes the corrected data of the right eye image 12R to the memory 18. Then the correction processor 42 starts the second step. The correction processor 42 reads the right eye image 12R from the memory 18, corrects data of the right eye image 12R according to the correction value X2, and then writes the corrected data to the memory 18. This sequence is repeated by the correction processor 42 in a similar manner until termination of the Kth step.

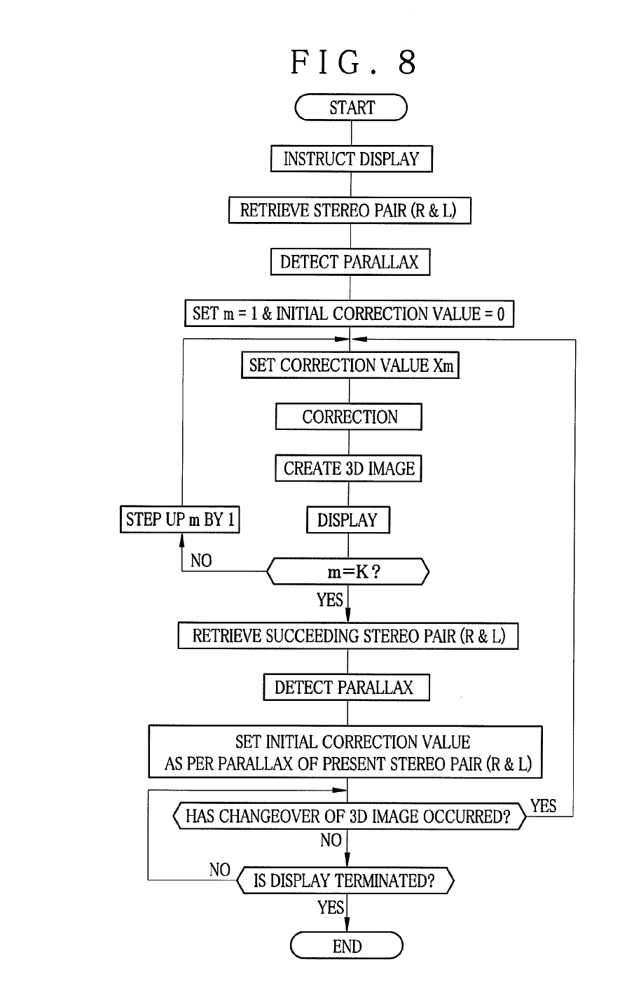

The autostereoscopic operation of the autostereoscopic display apparatus 10 is described by referring to the flow chart of FIG. 8. At first, a plurality of the image files 12 are written to the storage medium 20. Then the input panel 16 is manually operated for start. The CPU 15 responsively outputs a command signal to the image receiving device 25. The image receiving device 25 reads or retrieves a first one of the image files 12 from the storage medium 20, and temporarily stores the same.

Then the CPU 15 sends a command signal to the parallax checking device 26 for parallax detection. The parallax checking device 26 responsively reads the right and left eye images 12L and 12R from the image receiving device 25, and performs the tasks described with FIG. 3, such as the detection of a principal object, feature point detection, relevant point detection, creation of the relevant coordinate table, and parallax determination. Thus, the eight projective transformation parameters are obtained for the parallax information A or disparity information of the principal object 34 between the right and left eye images 12L and 12R. The parallax checking device 26 outputs the parallax information A to the condition generator 41.

After detecting the parallax information A, the CPU 15 outputs a command signal to the condition generator 41 to condition the correction by determining a correction value. In response to this, the condition generator 41 substitutes the parallax information A from the parallax checking device 26 and the initial correction value A0=(1,0,0,1,0,0,0,0) for the terms in Equation 13, and determines the correction value Xm of X1 to XK. Then the condition generator 41 outputs the correction value Xm to the correction processor 42.

After the correction value Xm is determined, the CPU 15 outputs a command signal to the correction processor 42 for correction. The correction processor 42 responsively reads the right and left eye images 12L and 12R from the image receiving device 25. Then the correction processor 42 writes the left eye image 12L to the memory 18, but corrects the right eye image 12R stepwise in the first to Kth steps according to the correction value Xm. In each of the first to Kth steps, the correction of the right eye image 12R and writing of the corrected form of the right eye image 12R to the memory 18 are carried out alternately.

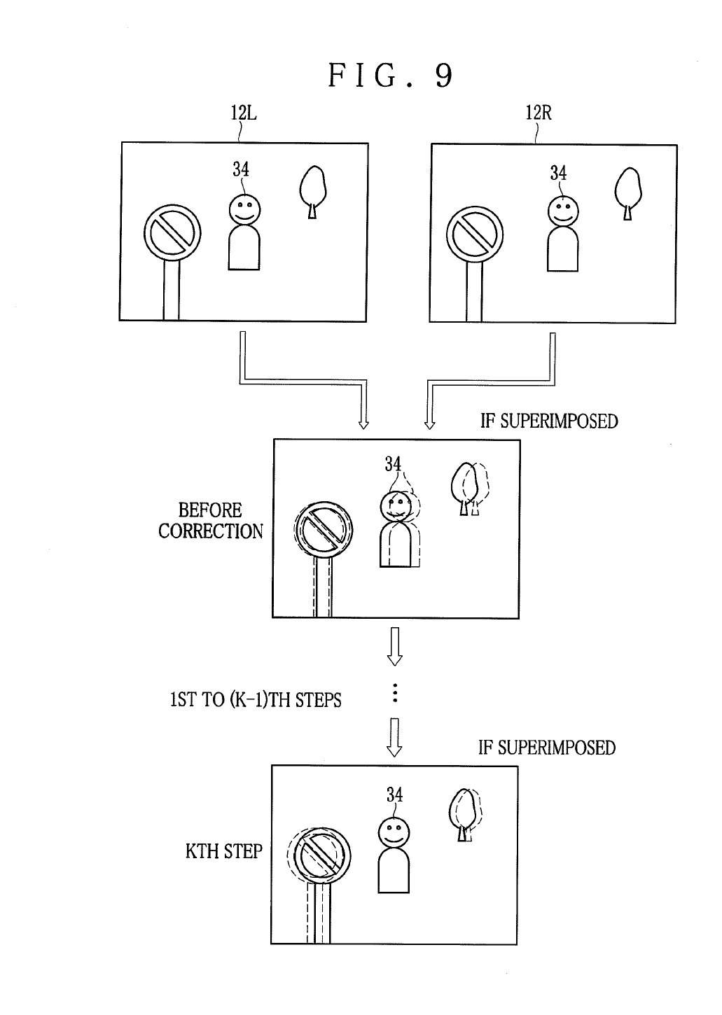

In FIG. 9, a superimposed image form according to the right and left eye images 12L and 12R is illustrated. FIG. 9 is for the purpose of illustrating a gradual decrease in the parallax information or disparity information of the principal object. The images are not actually superimposed in the manner of FIG. 9. The parallax or disparity occurs with the principal object 34 of the right and left eye images 12L and 12R before the correction. The left eye image 12L is indicated by the solid line. The right eye image 12R is indicated by the broken line. When the correction of the first to Kth steps is carried out stepwise, the parallax information of the principal object 34 of the right and left eye images 12L and 12R decreases gradually. When the correction of the Kth step is terminated, the parallax information decreases to zero (0) for stereo matching.

In FIG. 8, the CPU 15 outputs a command signal to the display control unit 22 for display at each time that the right eye image 12R in the memory 18 is updated. The display control unit 22 responsively reads the right and left eye images 12L and 12R successively from the memory 18, creates a three dimensional image, and outputs the three dimensional image to the monitor display panel 23.

When the correction of the Kth step in the correction processor 42 is completed, the CPU 15 generates a command signal to the image receiving device 25 for reading. The image receiving device 25 responsively reads a succeeding stereo pair from the storage medium 20, and overwrites the succeeding stereo pair over the present stereo pair. Note that FIG. 6B is referred to for the succeeding stereo pair.

After reading the succeeding stereo pair of right and left eye images, the CPU 15 outputs a command signal to the parallax checking device 26 for parallax detection. The parallax checking device 26 responsively reads the succeeding stereo pair from the image receiving device 25, performs tasks of the above sequence, and obtains parallax information A of the principal object 34 of the succeeding stereo pair. The parallax checking device 26 temporarily stores the parallax information A of the succeeding stereo pair until next changeover of the image with the input panel 16.

When a signal for changeover of an image is input with the input panel 16, the CPU 15 outputs a command signal to the parallax checking device 26 for retrieval of parallax information, and outputs a command signal to the condition generator 41 for conditioning of correction. In response, the parallax checking device 26 outputs the parallax information A for a succeeding stereo pair to the condition generator 41.

The condition generator 41 initially sets an initial correction value A0 as the parallax information A of the present stereo pair in response to the command signal for conditioning of correction. Then the condition generator 41 carries out substitution in Equation 13 for the parallax information A of the succeeding stereo pair and the initial correction value A0, and determines the correction value Xm for the succeeding stereo pair. The correction value Xm for the succeeding stereo pair is output by the condition generator 41 to the correction processor 42.

After determining the correction value Xm for the succeeding stereo pair, the CPU 15 outputs a command signal for correction to the correction processor 42. The correction processor 42 responsively carries out the image correction according to the correction value Xm in a manner similar to the that for the present stereo pair of the right and left eye images. Thus, data of the left eye image 12L is written to the memory 18. Data of the right eye image 12R corrected by respectively the first to Kth steps are written and updated. Also, the display control unit 22 creates a three dimensional image in response to a command signal from the CPU 15 at each time of writing and updating of the right eye image 12R, and causes the monitor display panel 23 to display the three dimensional image.

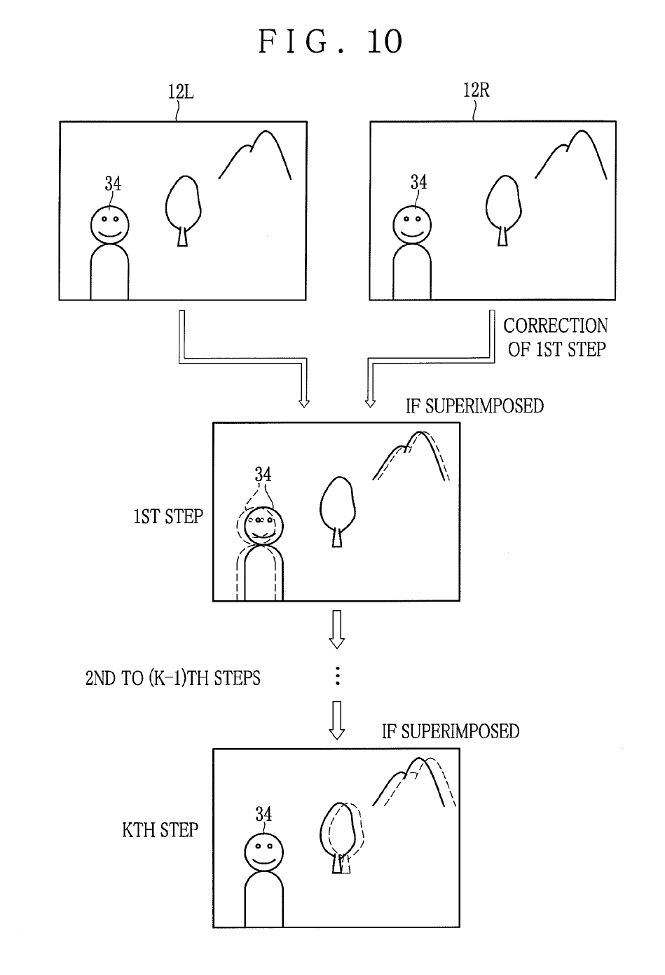

In FIG. 10, a superimposed image form of the succeeding stereo pair is illustrated. In the initial correction at the first step, the right eye image 12R is initially corrected to reduce the parallax information of the tree in the center area where the principal object 34 has been located in the present stereo pair of FIG. 9. Then the correction of the second to Kth steps are carried out stepwise. The parallax information of the principal object 34 on the left side gradually decreases. At the end of the Kth step of the correction, stereo matching of the principal object 34 is made. This sequence including the initial correction and the stepwise correction for gradual decrease is effective in preventing abrupt change in a stereo angle of a viewer's eyes even upon changeover of the display of the three dimensional image. It is possible to reduce physical fatigue of the viewer's eyes.

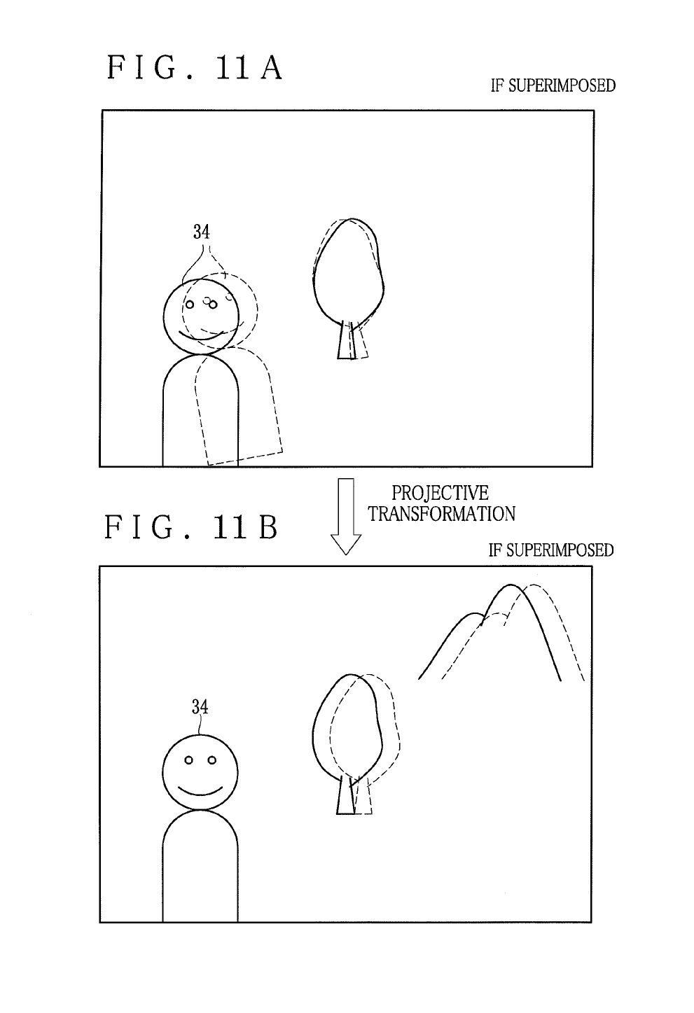

In the state of FIGS. 11A and 11B where the principal object 34 in the right eye image 12R has a difference from that in the left eye image 12L with translation and rotation, the right eye image 12R can be corrected to reduce the parallax information of the principal object 34 to zero (0) between the right and left eye images 12L and 12R by the projective transformation. Thus, stereo matching of the principal object 34 between the right and left eye images 12L and 12R can be made by the projective transformation even upon occurrence of the parallax of a complicated type between the right and left eye images 12L and 12R, for example with rotation, scaling for a larger or smaller size, trapezoidal distortion, and the like.

In FIG. 8, when the Kth step of the correction in the correction processor 42 is completed, the image receiving device 25 reads the succeeding stereo pair of right and left eye images. The parallax checking device 26 detects the parallax information A. While the three dimensional image according to the present stereo pair is displayed on the monitor display panel 23, the parallax information A of the succeeding stereo pair is determined. This is effective in immediately starting the correction upon changeover of the three dimensional image with the input panel even though arithmetic operation for the projective transformation parameters is highly complicated for the parallax information A. As a result, the three dimensional image can be changed over quickly on the monitor display panel 23.

Similarly the changeover of the display of the above three dimensional image is carried out repeatedly until the termination of displaying the three dimensional image, as a sequence from the determination of the correction value Xm to the question step for occurrence of the changeover in FIG. 8.

Another preferred embodiment is described now. In contrast with the above embodiment where parallax information is detected in the autostereoscopic display apparatus 10, parallax information is detected within a three dimensional camera for image pickup of the right and left eye images 12L and 12R. The parallax information is retrieved in an autostereoscopic display apparatus and considered.

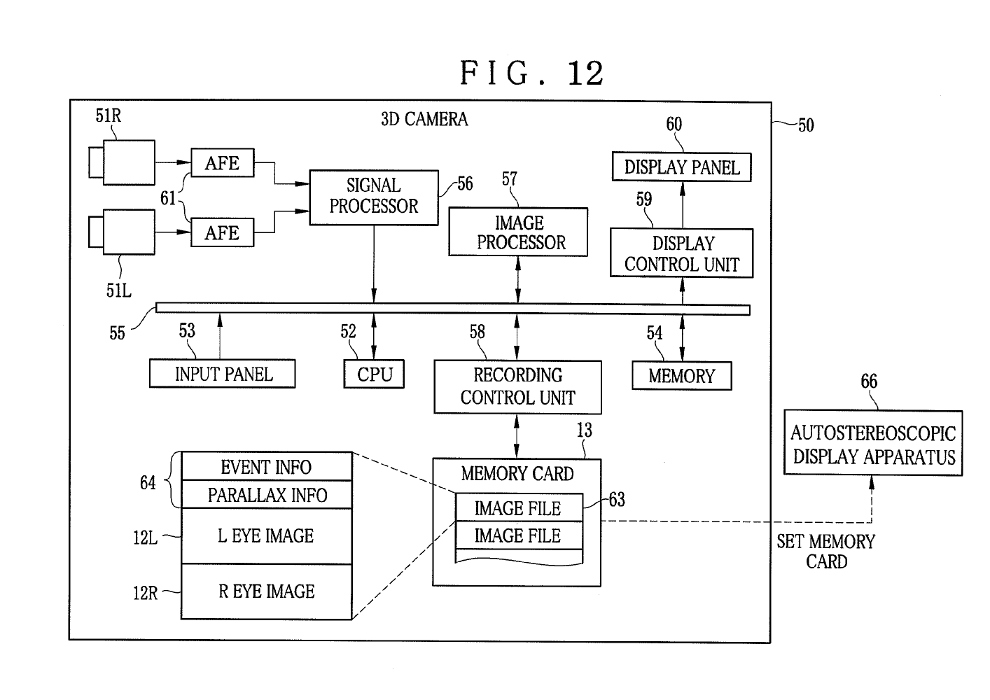

In FIG. 12, a three dimensional camera 50 or stereo camera or stereoscopic imaging apparatus includes a pair of imaging assemblies 51L and 51R. Each of the imaging assemblies 51L and 51R includes a lens optical system and a CCD or CMOS image sensor (not shown). The imaging assemblies 51L and 51R are arranged with such an interval as to keep the optical axes in parallel with one another.

The three dimensional camera 50 includes a CPU 52, an input panel 53 and a memory 54. The CPU 52 is supplied by a control signal from the input panel 53, reads various programs and data from the memory 54, performs tasks by running the programs, and controls the entirety of elements in the three dimensional camera 50. The elements are connected to the CPU 15 by a data bus 55, including a signal processor 56, an image processor 57 or parallax detection device, a recording control unit 58, a display control unit 59 and a monitor display panel 60 as well as the memory 54 and the input panel 53.

The input panel 53 includes a power switch, mode selection switch for changeover of a recording mode and playback mode of the three dimensional camera 50, shutter button, and the like. The shutter button is a two step switch. When the shutter button is depressed halfway, various functions are carried out prior to exposure, including exposure control and focusing. Then the shutter button is depressed fully with its depth, to photograph an image.

An analog front end 61 includes a correlated double sampling circuit (CDS), automatic gain control circuit (AGC), and A/D converter. The analog front end 61 processes image signals from the imaging assemblies 51L and 51R in an analog form for processing of reset noise elimination, amplification and conversion into a digital form, and creates data of the right and left eye images 12L and 12R. The analog front end 61 outputs the data of the right and left eye images 12L and 12R to the signal processor 56.

The signal processor 56 processes the right and left eye images 12L and 12R from the analog front end 61 for various functions of image processing, including the gradation conversion, white balance correction, gamma correction, Y/C conversion and the like. The signal processor 56 writes the right and left eye images 12L and 12R after the image processing to the memory 54.

The image processor 57 is structurally the same as the image processor 21 of FIGS. 2 and 3. The image processor 57 performs tasks of reading, detecting parallax information, and stereo matching. In the reading, the image processor 57 reads the image file 12 from the memory 54. In the parallax detection, the image processor 57 detects parallax information or projective transformation parameters of the principal object 34 within each of the right and left eye images 12L and 12R in the image file 12. In the stereo matching, the right eye image 12R is corrected to reduce the parallax information to zero (0) between the right and left eye images 12L and 12R. The image processor 57 writes the data of the left eye image 12L and the corrected form of the right eye image 12R to the memory 54.

Also, the image processor 57 writes the parallax information detected by the parallax detection to the memory 54. The parallax information in the memory 54 is updated by the image processor 57 at each time of the parallax detection.

The display control unit 59 and the monitor display panel 60 are basically the same as those of the first embodiment. At each time that one pair of the right and left eye images 12L and 12R is written by the image processor 57 to the memory 54, the display control unit 59 creates a three dimensional image by reading the right and left eye images 12L and 12R from the memory 54, and causes the monitor display panel 60 to display the three dimensional image by way of a live image.

When the shutter button of the input panel 53 is depressed fully, the recording control unit 58 reads data of the right and left eye images 12L and 12R and parallax information from the memory 54. An image file 63 is created in the recording control unit 58 by combining those data. Portions of the image file 63 include additional information 64 and data of the right and left eye images 12L and 12R assigned with the same. The additional information 64 includes the parallax information and event information of a date and time of the image pickup. The recording control unit 58 writes the image file 63 to the memory card 13.

In an autostereoscopic display apparatus 66 or stereoscopic image display apparatus, the structure of the autostereoscopic display apparatus 10 in FIGS. 1-3 is repeated with a difference in having a parallax information reading section (not shown), which is incorporated in the image processor 21 of FIG. 2, for reading parallax information from the image file 63 stored in the image receiving device 25.

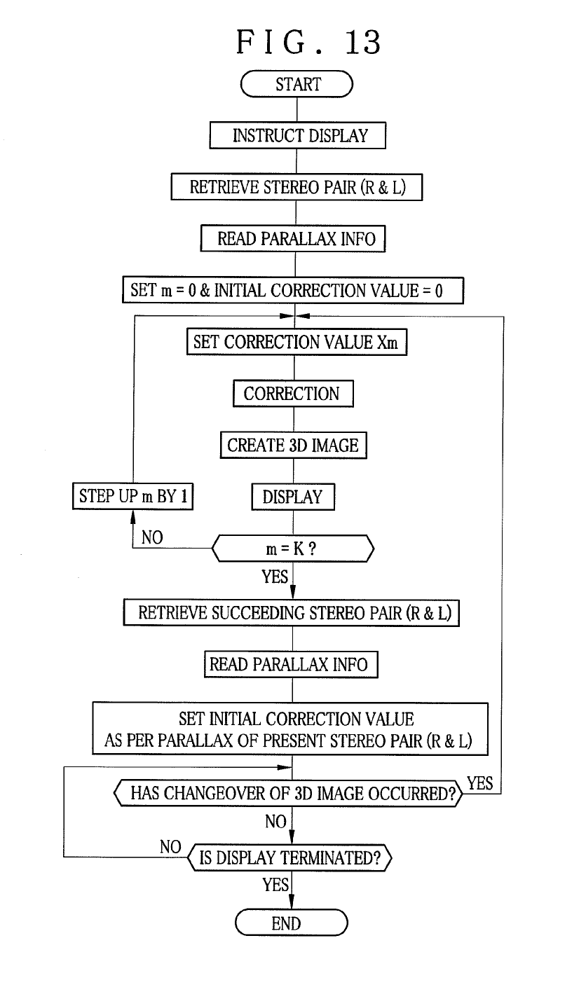

In FIG. 13, a sequence in the autostereoscopic display apparatus 66 to display a three dimensional image is the same as the above embodiment but with a difference in reading the parallax information from the additional information 64 of the right and left eye images 12L and 12R instead of detecting the parallax information of the principal object 34 between the right and left eye images 12L and 12R. The sequence is no further described herein. As the parallax information detected by the three dimensional camera 50 is used in the autostereoscopic display apparatus 66, it is unnecessary in the autostereoscopic display apparatus 66 to obtain the parallax information. This is effective in starting the correction of the right eye image 12R immediately upon changeover of images in a manner similar to the first embodiment. A three dimensional image on the monitor display panel 23 can be changed over quickly. Furthermore, the manufacturing cost of this structure can be smaller than that for the first embodiment, as the detection of the parallax information is unnecessary.

In each of the embodiments, the right eye image 12R is corrected according to the parallax information or disparity information between the right and left eye images 12L and 12R. However, the left eye image 12L may be corrected. It is also possible to correct both of the right and left eye images 12L and 12R. To this end, a half of the correction value of the above embodiments is used for each of the right and left eye images 12L and 12R.

In the embodiments, the autostereoscopic display apparatus retrieves the image file 12 from the memory card 13. Furthermore, the autostereoscopic display apparatus may retrieve the image file 12 by any known method, for example through a USB (Universal Serial Bus) cable from the three dimensional camera.

In the embodiments, the lenticular method is used. However, other methods of stereoscopic display may be used, including a parallax barrier method, disparity barrier method and anaglyphic method.

In the autostereoscopic display apparatus 10 or 66 in the above embodiments, the image files 12 and 63 are stored in the storage medium 20. However, the memory card 13 set on the data interface 19 can be used in place of the storage medium 20.

In the embodiments, the object detector 29 detects the principal object area 35 in the left eye image 12L. However, the object detector 29 can detect the principal object area 35 in the right eye image 12R, or in both of the right and left eye images 12L and 12R.

In the embodiments, the projective transformation is used for the stereo matching with the right eye image 12R. However, other geometric transformation of various methods may be used, for example an affine transformation. The affine transformation is a geometric transformation effective in considering translation, scaling, rotation and the like of an image, and is based on Equations 14 and 15 below. Those can be treated in the same manner as the equations in the projective transformation. The number of the parameters in Equations 14 and 15 is smaller than that in the above-described equations for the projective transformation. In short, the equations for the affine transformation are defined specifically when p=q=0 in those for the projective transformation.

X=ax+by+s [Equation 14]

Y=cx+dy+t [Equation 15]

In the embodiments, the autostereoscopic display apparatus is a separate component. However, an autostereoscopic display apparatus of the invention may be incorporated in an instrument of any type for photographing the right and left eye images 12L and 12R, such as a three dimensional camera or other optical instruments.

A three dimensional image according to the invention can be not only a still image but also a moving image.

Although the present invention has been fully described by way of the preferred embodiments thereof with reference to the accompanying drawings, various changes and modifications will be apparent to those having skill in this field. Therefore, unless otherwise these changes and modifications depart from the scope of the present invention, they should be construed as included therein.

What is claimed is:

1. A stereoscopic image display apparatus comprising:
an image receiving device for retrieving right and left eye images of plural stereo pairs from a storage medium by one pair;
a parallax checking device for determining parallax information of parallax of a common principal object present in each of said right and left eye images of an Nth stereo pair, where N is an integer;
a stereo matching unit for correcting at least one particular image of said right and left eye images of said Nth stereo pair to minimize said parallax information being determined;
a display panel for displaying an Nth three dimensional image according to said right and left eye images of said Nth stereo pair after correction; and
a controller for, while said display panel displays said Nth three dimensional image, causing retrieval of said right and left eye images of an (N+1)th stereo pair and determination of said parallax information thereof with said image receiving device and said parallax checking device with respect to said (N+1)th stereo pair.

2. A stereoscopic image display apparatus as defined in claim 1, wherein said parallax checking device includes:
an image analysis unit for image analysis of said right and left eye images;
a parameter determiner for determining a geometric transformation parameter to represent said parallax information of said object between said right and left eye images according to a result of said image analysis;
said stereo matching unit corrects said particular image according to geometric transformation by use of said geometric transformation parameter.

3. A stereoscopic image display apparatus as defined in claim 2, wherein said geometric transformation is projective transformation or affine transformation.

4. A stereoscopic image display apparatus as defined in claim 2, wherein said image analysis unit includes:
an object detector for detecting said object from said right and left eye images;
a feature point detector for detecting a feature point associated with said object within said particular image;
a relevant point detector for detecting a relevant point corresponding to said feature point from said object within a remaining image of said right and left eye images.

5. A stereoscopic image display apparatus as defined in claim 4, wherein said parameter determiner obtains said geometric transformation parameter by a method of least squares according to said feature point and said relevant point.

6. A stereoscopic image display apparatus as defined in claim 1, further comprising a changeover device for changing over said three dimensional image on said display panel;
wherein said stereo matching unit carries out said correction of at least one of said right and left eye images of said (N+1)th stereo pair according to said parallax information upon changeover of said changeover device from said Nth three dimensional image to an (N+1)th three dimensional image.

7. A stereoscopic image display apparatus as defined in claim 1, wherein said stereo matching unit carries out correction gradually to decrease said parallax information;
said display panel updates display of said three dimensional image at each time of correction of said parallax information with said stereo matching unit.

8. A stereoscopic image display apparatus as defined in claim 1, wherein said stereo matching unit carries out initial correction to minimize second parallax information of an area of said object within said right and left eye images of said Nth stereo pair equal to an area of presence of a common principal object in right and left eye images of an (N−1)th stereo pair, according to parallax information determined earlier by said parallax checking device for said (N−1)th stereo pair;
then said stereo matching unit carries out correction gradually to decrease said parallax information of said right and left eye images after said initial correction.

9. A stereoscopic image display apparatus as defined in claim 1, wherein said right and left eye images are photographed by a stereoscopic imaging apparatus including:
first and second imaging assemblies, disposed beside one another, for creating said right and left eye images by photographing said object;
a parallax detection device for detecting parallax information of said object present in said right and left eye images from said first and second imaging assemblies;
a recording control unit for writing data of said right and left eye images and said parallax information of said object associated with said right and left eye images to a storage medium; and
wherein said parallax checking device reads said parallax information from said storage medium for determination thereof.

10. A stereoscopic image display apparatus as defined in claim 1, wherein said display panel splits said particular image being corrected into stripe regions of a first group extending in a predetermined direction, splits a remaining image of said right and left eye images into stripe regions of a second group extending in said predetermined direction, and creates said three dimensional image according to a lenticular method by alternately combining said stripe regions of said first and second groups.

11. A changeover method of changing over display of a three dimensional image, comprising steps of:
retrieving right and left eye images of plural stereo pairs from a storage medium by one pair;
determining parallax information of parallax of a common principal object present in each of said right and left eye images of an Nth stereo pair, where N is an integer;
correcting at least one particular image of said right and left eye images of said Nth stereo pair to minimize said parallax information being determined;
displaying an Nth three dimensional image on a display panel according to said right and left eye images of said Nth stereo pair; and
while said display panel displays said Nth three dimensional image, carrying out said retrieving step and said determining step with respect to an (N+1)th stereo pair.

12. A changeover method as defined in claim 11, wherein said correcting step and said display step are carried out for said (N+1)th stereo pair when said display panel is changed over from said Nth three dimensional image to an (N+1)th three dimensional image.
